(19) United States
(12) Patent Application Publication
(10) Pub. No.: US 2014/0367396 A1
(43) Pub. Date: Dec. 18, 2014

(54) POCKET FOR CATCHING AND RETRIEVING DROPPED ITEMS

(71) Applicant: CatchDrop, LLC, China Gove, TX (US)

(72) Inventors: Matthew R. Schmalz, China Grove, TX (US); Corey D. Cline, Floresville, TX (US)

(21) Appl. No.: 13/919,690

(22) Filed: Jun. 17, 2013

(51) Int. Cl. B60R 11/00

(52) U.S. Cl. CPC B60R 11/00; B60R 2011/0012
USPC 220/666

(57) ABSTRACT

A pocket for catching and retrieving items inadvertently dropped in and about the space between a vehicle seat and a vehicle seat console includes two semi-rigid sidewalls extending upwardly from a base and two collapsing walls extending upwardly from the base, which is sized and shaped to be received with the space between the vehicle seat the vehicle seat console. Flexible curtain disposed about and along the top edges of the sidewalls facilitate catching of dropped items. Springs associated with the collapsing walls push the sidewalls apart to maintain placement of the pocket in the space between the vehicle seat and vehicle seat console and to ensure that the pocket is open for catching dropped articles.

### FIELD OF THE INVENTION

The present invention relates to carriers for use within automobiles. More particularly, the invention relates to a carrier to be associated with the seat of a vehicle for catching and facilitating retrieval of dropped items.

### BACKGROUND OF THE INVENTION

Drivers and passengers of motor vehicles have long been plagued with the problem of inadvertently dropping small articles between a vehicle seat and seat console, where the article is extremely difficult to retrieve. Although some attention has of late been given to this persistent problem, the known solutions to date have generally focused on providing articles that block the space between a vehicle seat and a vehicle seat console. Unfortunately, this solution is inadequate to the extent that items may still bounce to the floor and, in the case of foodstuffs in particular, the items are generally deflected onto the clothing of the seat occupant or the seat's upholstery.

It is therefore an overriding object of the present invention to improve over the prior art by presenting a novel article that catches inadvertently dropped items and, thereafter, facilitates their retrieval. Additionally, it is an object of the present invention to present such an article that is also extremely simple and reliable to use, thereby ensuring that the article may be readily deployed in virtually any vehicle. Finally, it is an object of the present invention to present such an article that is also economical in manufacture, thereby making the article appropriate for use as an advertising of like device.

### SUMMARY OF THE INVENTION

In accordance with the foregoing objects, the present invention—a pocket for catching and retrieving items inadvertently dropped in and about the space between a vehicle seat and a vehicle seat console—generally comprises a first semi-rigid sidewall extending upwardly from a base; a second semi-rigid sidewall extending upwardly from the base; a first collapsing wall extending upwardly from the base; and a second collapsing wall extending upwardly from the base. The base is sized and shaped to be received with the space between the vehicle seat the vehicle seat console, the first semi-rigid sidewall comprises a first flexible curtain disposed about and along its top edge and the second semi-rigid sidewall comprises a second flexible curtain disposed about and along its top edge. The first semi-rigid sidewall is interposed between a first end of the first semi-rigid sidewall and a first end of the second semi-rigid sidewall and the second collapsing wall is interposed between a second end of the first semi-rigid sidewall and a second end of the second semi-rigid sidewall. The first collapsing wall has associated therewith a first spring adapted to push the first end of the first semi-rigid sidewall away from the first end of the second semi-rigid sidewall and the second collapsing wall has associated therewith a second spring adapted to push the second end of the first semi-rigid sidewall away from the second end of the second semi-rigid sidewall.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a perspective view, the most preferred implementation of the pocket for catching and retrieving dropped items of the present invention;

FIG. 2 shows, in a front end elevational view, the pocket of FIG. 1;

FIG. 3 shows, in a perspective view, the pocket of FIG. 1 as operatively disposed between a vehicle seat and a vehicle seat console;

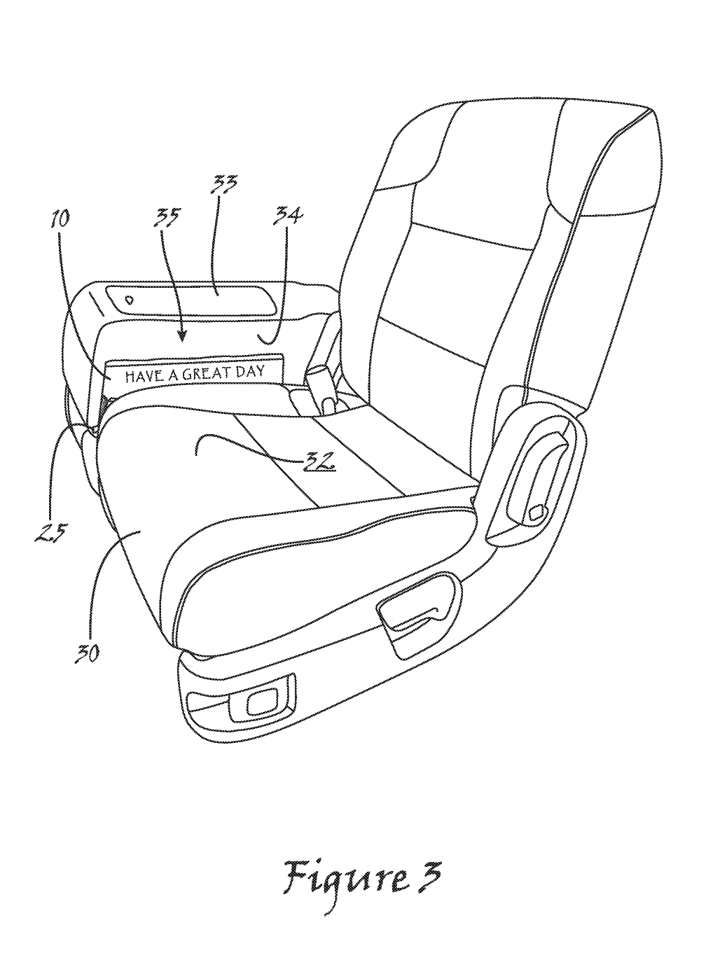

FIG. 4 shows, in a front elevational view, various details of the pocket of FIG. 1 as disposed in FIG. 3;

FIG. 5 shows, in a top plan view, various additional details of the pocket of FIG. 1 as disposed in FIG. 3; and

FIG. 6 shows, in a side elevational view, yet further details of the pocket of FIG. 1 as disposed in FIG. 3.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

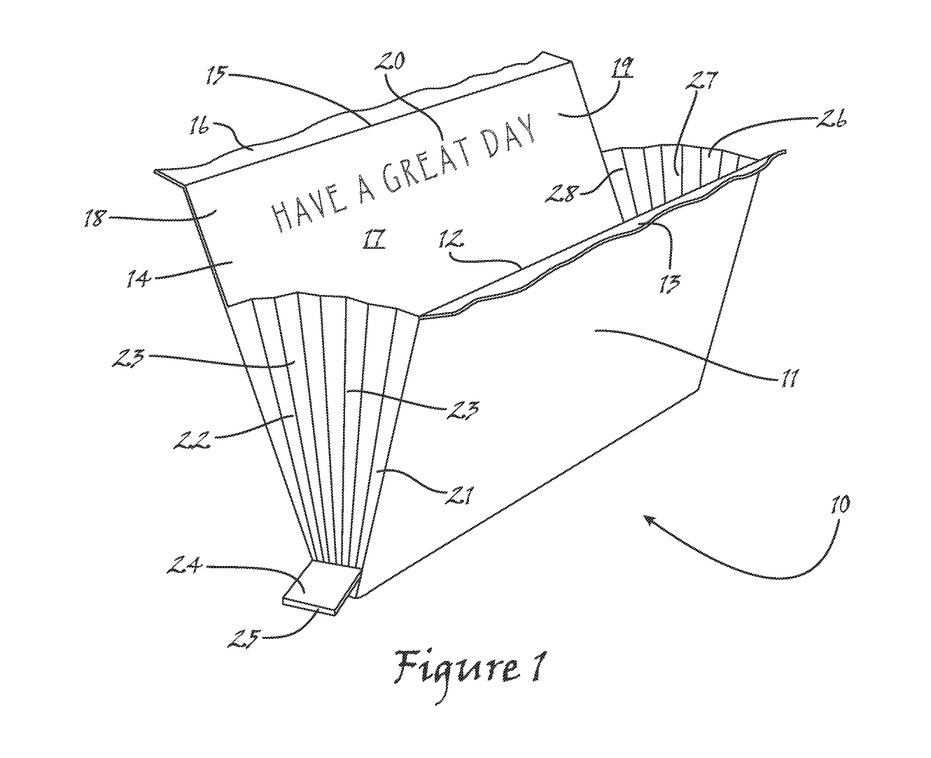

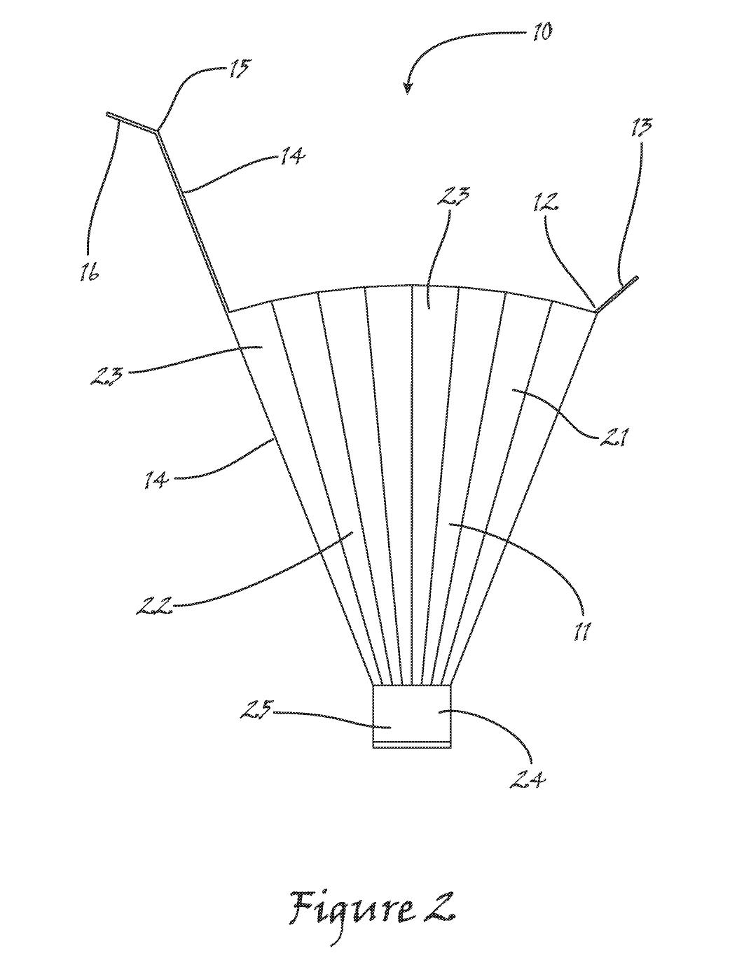

Referring now to the figures, and to FIGS. 1 and 2 in particular, the most preferred implementation of the pocket 10 of the present invention is shown to generally comprise a first, seat-side sidewall 11; a second, console-side sidewall 14; a first, front collapsing wall 21 and a second, rear collapsing wall 26, each dependently attached to and extending upwardly from a preferably elongate base 29. In accordance with the present invention, each sidewall 11, 14 is manufactured as a semi-rigid panel that is sufficiently flexible to generally bend about or otherwise conform to the console-side sidewall 31 of a vehicle seat 30 and the seat-side sidewall 34 of a vehicle seat console 33, respectively, but that is sufficiently rigid as to maintain the general form as depicted in the various figures. Each collapsing wall 21, 26, on the other hand, is in accordance with the present invention manufactured to enable the sidewalls 11, 14 to be squeezed one to the other under external force. In order to maintain the sidewalls 11, 14 in their operative positions adjacent to the console-side sidewall 31 of a vehicle seat 30 and the seat-side sidewall 34 of a vehicle seat console 33, respectively, each collapsing wall 21, 26 is also formed as or otherwise provided with a spring 22, 27, respectively, configured or otherwise adapted to firmly push the sidewalls 11, 14 apart, especially at their upper portions. In this manner, as will be better understood further herein, the pocket 10 of the present invention may be readily inserted into, and retrieved from, the space 35 between the console-side sidewall 31 of a vehicle seat 30 and the seat-side sidewall 34 of a vehicle seat console 33 and, when in place, the pocket 10 will be automatically opened to catch any item that may be inadvertently dropped into the space 35.

As previously suggested, each spring 22, 27 of the provided collapsing walls 21, 26 of the pocket may be formed unitary with its respective collapsing wall 21, 26 or may be provided integral with or otherwise attached to the respective collapsing wall 21, 26. In the most preferred embodiment of the present invention, Applicant has found it convenient and effective to provide the springs 22, 27 unitary with the collapsing walls 21, 26 in the form of accordion type pleats 23, 28, respectively, that are manufactured or otherwise adapted to be biased toward expansion. As those of ordinary skill in the art will recognize in light of this exemplary description (including the foregoing discussions and the discussions to follow, as well), however, the required springs 22, 27 could also be implemented by attaching, in various locations about the upper portion of the pocket 10, otherwise conventional springs, which springs, of course, would be provided in compression between the sidewalls 11, 14.

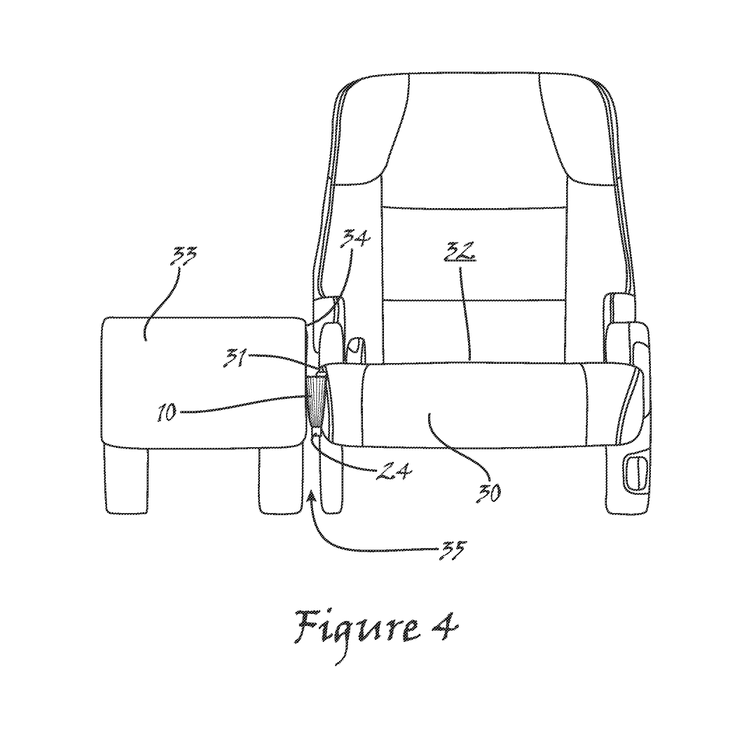

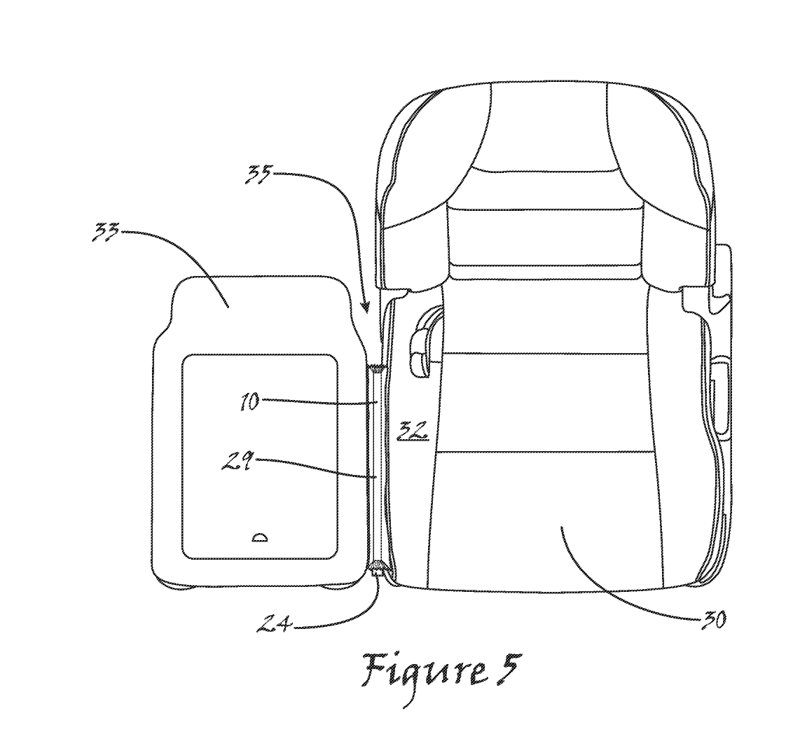

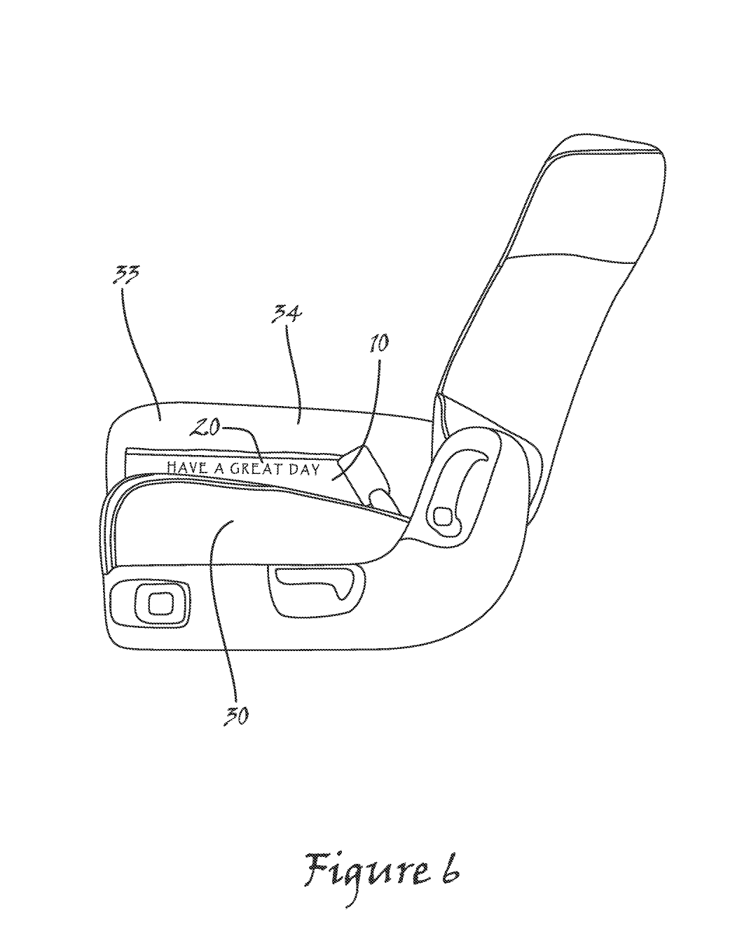

In any case, in order to doubly ensure that an inadvertently dropped item finds its way into the pocket 10 of the present invention, the sidewalls 11, 14 are specifically adapted for maximum conformance with the console-side sidewall 31 of a vehicle seat 30 and the seat-side sidewall 34 of a vehicle seat console 33, respectively. More specifically, and as particularly shown in FIGS. 4 through 6, the second, console-side sidewall 14 is most preferably manufactured to extend substantially above opening into the top of the pocket 10. In this manner, while the main body of the pocket 10 is generally disposed out of sight below the level of the top surface 32 of the vehicle seat 30, the second, console-side sidewall 14 extends further upward in order to deflect and/or otherwise guide falling objects into the interior space of the pocket 10.

Additionally, however, a generally flaccid curtain 13 is formed or otherwise provided along the top edge 12 of the first, seat-side sidewall 11 of the pocket 10 and, likewise, a generally flaccid curtain 16 is formed or otherwise provided along the top edge 15 of the second, console-side sidewall 14 of the pocket 10. As those of ordinary skill in the art will recognize in light of this exemplary description (including the foregoing discussions and the discussions to follow, as well), the provided curtains 13, 16 will readily fill any space that may otherwise exist between the top edge 12 of the first, seat-side sidewall 11 and the console-side sidewall 31 of the vehicle seat 30 and between the top edge 15 of the second, console-side sidewall 14 and the seat-side sidewall 34 of the vehicle console 33. In this manner, the pocket 10 of the present invention is specifically adapted to ensure that the sidewalls 11, 14 of the pocket 10 conform about the console-side sidewall 31 of a vehicle seat 30 and the seat-side sidewall 34 of a vehicle seat console 33, respectively, without gaps, even in cases of the console-side sidewall 31 of a vehicle seat 30 and/or the seat-side sidewall 34 of a vehicle seat console 33 having a very curved or otherwise complex profile.

As particularly shown in FIGS. 4 through 6, the pocket 10 of the present invention as depicted in FIGS. 1 and 2 in its most preferable implementation, is simply tucked into place in the space 35 between the host vehicle's seat 30 and console 33 with the top edge 12 of the first, seat-side sidewall 11 of the pocket being positioned slightly below the level of the top surface 32 of the vehicle seat 30. In a dramatic improvement over the prior art, the springs 22, 27 formed unitary, integral or otherwise provided in connection with the collapsing sidewalls 21, 26 will (1) enable easy insertion of the pocket 10 into its described operable position and (2) serve to automatically (a) secure the pocket 10 operably in place, (b) conform the sidewalls 11, 14 adjacent to the console-side sidewall 31 of the vehicle seat 30 and the seat-side sidewall 34 of the vehicle seat console 33 and (c) ensure that the pocket 10 is wide open for catching any inadvertently dropped item. In order to facilitate removal of the pocket from the space 35 between the host vehicle's seat 30 and console 33, for retrieval of a dropped object and/or periodic cleaning of the pocket 10, a pull 24, such as, for example, a tab 25 as depicted in the figures or, in the alternative, a D-ring, tether or other substantially equivalent device, is most preferably provided about the base of the first, front collapsing wall 21. As will be appreciated by those of ordinary skill in the art, the provided tab 25 or other pull 24 may be utilized to readily draw the pocket 10 out from within the space 35 between the host vehicle's seat 30 and console 33.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, as shown in the various figures, the present invention also contemplates that the upper portion 18 of the interior face 17 of the second, console-side sidewall 14 may be utilized as a placard, marquee or like signboard 19 for the display of printed or like matter 20. In this manner, it is contemplated that automobile manufacturers, dealers or repair shops, or any other commercial enterprise, may utilize the pocket 10 as a “giveaway” item serving to advertise the enterprises other goods and/or services. In any case, because the scope of the present invention is much broader than any particular embodiment, the foregoing detailed description should not be construed as a limitation of the scope of the present invention, which is limited only by the claims appended hereto.

What is claimed is:

1. A pocket for catching and retrieving items inadvertently dropped in and about the space between a vehicle seat and a vehicle seat console, said pocket comprising:
a first semi-rigid sidewall extending upwardly from a base sized and shaped to be received with the space between the vehicle seat and the vehicle seat console, said first semi-rigid sidewall comprising a first flexible curtain disposed about and along the top edge of said first semi-rigid sidewall;
a second semi-rigid sidewall extending upwardly from said base, said second semi-rigid sidewall comprising a second flexible curtain disposed about and along the top edge of said second semi-rigid sidewall;
a first collapsing wall extending upwardly from said base and interposed a first end of said first semi-rigid sidewall and a first end of said second semi-rigid sidewall, said first collapsing wall having associated therewith a first spring adapted to push said first end of said first semi-rigid sidewall away from said first end of said second semi-rigid sidewall; and
a second collapsing wall extending upwardly from said base and interposed a second end of said first semi-rigid sidewall and a second end of said second semi-rigid sidewall, said second collapsing wall having associated therewith a second spring adapted to push said second end of said first semi-rigid sidewall away from said second end of said second semi-rigid sidewall.

2. The pocket for catching and retrieving items inadvertently dropped in and about the space between a vehicle seat and a vehicle seat console as recited in claim 1, wherein said second semi-rigid sidewall extends a distance above said first semi-rigid sidewall.

3. The pocket for catching and retrieving items inadvertently dropped in and about the space between a vehicle seat and a vehicle seat console as recited in claim 2, wherein said second semi-rigid sidewall forms a placard for presentation of printed matter.

4. The pocket for catching and retrieving items inadvertently dropped in and about the space between a vehicle seat and a vehicle seat console as recited in claim 1, wherein said first spring is formed unitary with said first collapsing wall and said second spring is formed unitary with said second collapsing wall.

5. The pocket for catching and retrieving items inadvertently dropped in and about the space between a vehicle seat and a vehicle seat console as recited in claim 4, wherein said second semi-rigid sidewall extends a distance above said first semi-rigid sidewall.

6. The pocket for catching and retrieving items inadvertently dropped in and about the space between a vehicle seat and a vehicle seat console as recited in claim 5, wherein said second semi-rigid sidewall forms a placard for presentation of printed matter.

7. The pocket for catching and retrieving items inadvertently dropped in and about the space between a vehicle seat and a vehicle seat console as recited in claim 6, wherein said first collapsing wall comprises a pull adapted for retrieving said pocket from the space between a vehicle seat and a vehicle seat console.

8. The pocket for catching and retrieving items inadvertently dropped in and about the space between a vehicle seat and a vehicle seat console as recited in claim 5, wherein said first collapsing wall comprises a pull adapted for retrieving said pocket from the space between a vehicle seat and a vehicle seat console.

9. The pocket for catching and retrieving items inadvertently dropped in and about the space between a vehicle seat and a vehicle seat console as recited in claim 4, wherein said first collapsing wall comprises a pull adapted for retrieving said pocket from the space between a vehicle seat and a vehicle seat console.

10. The pocket for catching and retrieving items inadvertently dropped in and about the space between a vehicle seat and a vehicle seat console as recited in claim 1, wherein said first collapsing wall comprises a pull adapted for retrieving said pocket from the space between a vehicle seat and a vehicle seat console.
